(19) United States
(12) Patent Application Publication
(10) Pub. No.: US 2009/0239609 A1
(43) Pub. Date: Sep. 24, 2009

(54) Gaming Machine Executing A Bonus Game And Control Method Thereof

(75) Inventor: Nakayasu TSUKAHARA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/172,722

(22) Filed: Jul. 14, 2008

Related U.S. Application Data
(60) Provisional application No. 61/038,522, filed on Mar. 21, 2008.

(51) Int. Cl. A63F 9/24; A63F 13/00

(52) U.S. Cl. 463/20

(57) ABSTRACT

According to the gaming machine of the present invention, a total payout amount is determined in a bonus game in which a unit game is played over a plurality of times, the unit game determining a payout based on symbols or a combination of the symbols that have been rearranged and displayed to a display. In each of the unit games constituting the bonus game, the symbols are rearranged in a manner that the payout amount to be offered is equal to or less than a remaining payout amount obtained by subtracting a total amount of payout having been offered up to the time in the bonus game from the above-determined total payout amount.

### CROSS-REFERENCE TO RELATED APPLICATIONS

This application claims benefit of priority based on U.S. Provisional Patent Application No. 61/038,522 filed on Mar. 21, 2008. The contents of this application are incorporated herein by reference in their entirety.

### BACKGROUND OF THE INVENTION

1. Field of the Invention

The present invention relates to a gaming machine executing a bonus game and a control method thereof.

2. Discussion of the Background

Conventionally, there exists a slot machine that executes a free game as a bonus game when a prescribed condition (e.g. specific symbols are rearranged in a slot machine game) is established during a game. The free game is a game that can be played without consuming game media. For example, Australian Patent Publication No. 1972901 discloses a slot machine on which a free game is played as a side game when a prescribed condition (i.e. symbols are arranged in a specific pattern) is established in a basic game.

In the slot machine game as described above, the free game may often be the biggest chance for a player to obtain a large payout, and for a manufacturer of the gaming machine, in the case where a large amount of payout are going to be offered, it is ideal to make the player aware of the payout by the effect of a plurality of free games so as to raise an expectation of the player.

However, since a conventional slot machine decides a payout to be offered in a free game at random every time the free game is played, a total payout amount over a plurality of free games is greatly varied. Hence, even if effects suggesting a large amount of payout are performed over the plurality of free games, there is a possibility that an amount of the actually offered total payout becomes significantly smaller than an amount of an expected payout, and thus contents of the effects turn out to be false. This may cause a problem that the player has distrust in the game, the gaming machine, and further a manufacturer of the gaming machine.

The present invention was made in view of the foregoing problem, and an object of the present invention is to provide a gaming machine capable of performing an appropriate effect reflecting a total payout amount in a bonus game, and a method for controlling the gaming machine.

The contents of Australian Patent Publication No. 1972901 are incorporated herein by reference in their entirety.

### SUMMARY OF THE INVENTION

A first embodiment of the present invention provides a gaming machine having the following configuration.

Namely, the gaming machine includes a display capable of arranging symbols. Further, the gaming machine includes a controller programmed to execute the processing of (a) executing a normal game in which the symbols are rearranged and displayed to the display, (b) determining whether or not to execute a bonus game in which a unit game is played over a plurality of times, the unit game executing rearrangement and display of the symbols to the display and determining a payout based on the rearranged symbols or a combination of those symbols, (c) determining a total payout amount in the bonus game, and (d) executing, when it is determined in the processing (b) that the bonus game will be executed, rearrangement and display of the symbols to the display in a manner that a payout amount offered in each of the unit games constituting the bonus game becomes equal to or less than a remaining payout amount obtained by subtracting a total amount of payout having been offered up to the time in the bonus game from the total payout amount determined in the processing (c).

According to the above gaming machine, the total payout amount is determined in a bonus game in which a unit game is played over a plurality of times, the unit game executing rearrangement and display of the symbols to the display, and determining a payout based on the rearranged symbols or a combination of those symbols. Moreover, the rearrangement of the symbols is executed in a manner that a payout amount offered in each of the unit games constituting the bonus game becomes equal to or less than a remaining payout amount obtained by subtracting a total amount of payout having been offered up to the time in the bonus game from the above-determined total payout amount.

Namely, on the above gaming machine, a total payout amount in the bonus game is determined prior to execution of the bonus game, while the arrangement of the symbols is controlled so that a total of the payout amounts of the respective unit games constituting the bonus game should not surpass the above-mentioned total payout amount. Therefore, it becomes possible to control the payout amount in the bonus game by adjusting a payout amount in each of the unit games with reference to the payout amount determined prior to execution of the bonus game. As a result, an effect which more accurately reflects the total payout amount in the bonus game can be performed.

Moreover, since the payout amount in the bonus game is controlled by making an adjustment in each of the unit games, data showing rearrangement patterns of the symbols in each of the unit games do not need to be stored. Therefore, it is possible to reduce the memory capacity to be used.

Furthermore, since the payout amount in the bonus game is controlled by making an adjustment in each of the unit games, the payout amount in the bonus game can be adjusted irrespective of the number of the unit games constituting the bonus game. Therefore, the number of the unit games can be variously changed.

Preferably, the above-mentioned gaming machine further has the following configuration.

Namely, the processing (d) is processing of executing rearrangement and display of the symbols to the display in a manner that a payout amount offered in the last unit game in the bonus game becomes equal to the remaining payout amount.

According to the above gaming machine, the control to adjust the payout amount in the bonus game to be equal to the above-mentioned total payout amount is performed in the last unit game in the bonus game. By performing this control, the payout amount in the bonus game can be more accurately adjusted.

Preferably, the above-mentioned gaming machine further has the following configuration.

Namely, the gaming machine is further provided with a memory that stores a plurality of kinds of effect pattern data for use in executing an effect, each of the effect pattern data being corresponded to the total payout amount in the bonus game, and the controller is further programmed to execute the processing of (e) selecting one effect pattern data out of the effect pattern data corresponded to the total payout amount determined in the processing (c), among the plurality of kinds of the effect pattern data stored in the memory, and (f) executing, when it is determined in the processing (b) that the bonus game will be executed, an effect based on the effect pattern data selected in the processing (e) in each of the unit games constituting the bonus game.

Namely, according to the above gaming machine, the bonus game is played after a total payout amount in the bonus game has been determined, and further, an effect is executed based on effect pattern data corresponding to the determined total payout amount. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an appropriate effect in accordance with the total payout amount to be offered can be executed, it is possible to avoid a condition where a payout expected from the effect is significantly different from an actual total payout amount. Therefore it becomes possible to prevent the player from being mistrustful of the game.

Moreover, since effects depending on the total payout amount determined prior to execution of the bonus game can be executed as a series of effects over a plurality of the unit games, it is possible to gradually raise the expectation of the player for the results of the bonus game each time the unit game is played. It is thus possible to further increase amusement of the bonus game.

A second embodiment of the present invention provides a gaming machine having a following configuration.

Namely, the gaming machine includes a display capable of arranging symbols. Further, the gaming machine includes a controller programmed to execute the processing of an arranging symbols; and a controller, the controller programmed to execute processing of (a) executing a normal game in which the symbols are rearranged and displayed to the display, (b) determining whether or not to execute a bonus game in which a unit game is played over a plurality of times, the unit game executing rearrangement and display of the symbols to the display, (c) determining a total payout amount in the bonus game, and (d) executing, when it is determined in the processing (b) that the bonus game will be executed, rearrangement of the symbols to the display in each of the unit games constituting the bonus game, while determining a payout amount offered in each of the unit games so as to be equal to or less than a remaining payout amount obtained by subtracting a total amount of payout having been offered up to the time in the bonus game from the total payout amount determined in the processing (c), and then notifying the determined payout amount.

According to the above gaming machine, the total payout amount is determined in the bonus game in which a unit game executing rearrangement of the symbols is played over a plurality of times. In each of the unit games constituting the bonus game, rearrangement of the symbols is executed, while a payout amount to be offered is determined in a manner that the payout amount becomes equal to or less than a remaining payout amount obtained by subtracting a total amount of payout having been offered up to the time in the bonus game from the above-determined total payout amount. Subsequently, notification of the determined payout is performed.

Namely, on the above gaming machine, a total payout amount in the bonus game is determined prior to execution of the bonus game. In the bonus game, independently to the rearrangement of the symbols, the payout amount is determined by controlling such that a total of the payout amounts of the respective unit games should not surpass the above-mentioned total payout amount.

Therefore, it becomes possible to control the payout amount in the bonus game by adjusting a payout amount in each of the unit games with reference to the payout amount determined prior to execution of the bonus game. As a result, an effect which more accurately reflects the total payout amount in the bonus game can be performed.

Moreover, since the payout amount in the bonus game is controlled by making an adjustment in each of the unit games, data showing payout pattern of the symbols in each of the unit games do not need to be stored. Therefore, it is possible to reduce the memory capacity to be used.

Further, since the payout amount in the bonus game is controlled by making an adjustment in each of the unit games, the payout amount in the bonus game can be adjusted irrespective of the number of the unit games constituting the bonus game. Therefore, the number of the unit games can be variously changed.

Furthermore, since the payout amount in each of the unit games is determined irrespective of the rearrangement of the symbols, it is not necessary to determine the corresponding relation between the rearranged symbols and the payout in advance. In addition, it becomes possible to employ various payouts to be offered, such as setting of larger varieties of payout patterns than the number of combinations of the rearranged symbols.

Preferably, the above-mentioned gaming machine further includes the following configuration.

Namely, the processing (d) includes processing of determining a payout amount to be offered in the last unit game in the bonus game to be equal to the remaining payout amount, and processing of notifying the determined payout amount.

According to the above gaming machine, the control to adjust the payout amount in the bonus game to be equal to the above-mentioned total payout amount is performed in the last unit game in the bonus game. By performing this control, the payout amount in the bonus game can be more accurately adjusted.

Preferably, the above-mentioned gaming machine further has the following configuration.

Namely, the processing (d) is processing of executing, when it is determined in the processing (b) that the bonus game will be executed, rearrangement of the symbols to the display in each of the unit games constituting the bonus game, while determining a payout amount offered in each of the unit games so as to be equal to or less than a remaining payout amount obtained by subtracting a total amount of payout having been offered up to the time in the bonus game from the total payout amount determined in the processing (c), and then notifying the determined payout by displaying an image to the display.

According to the above gaming machine, since the payout in each of the unit games is notified by an image, the player can more accurately recognize the payout.

Preferably, the above-mentioned gaming machine further has the following configuration.

Namely, the gaming machine further includes a memory that stores a plurality of kinds of effect pattern data for use in executing an effect, each of the effect pattern data being corresponded to the total payout amount in the bonus game, and the controller programmed to execute processing of (e) selecting one effect pattern data out of the effect pattern data corresponded to the total payout amount determined in the processing (c), among the plurality of kinds of the effect pattern data stored in the memory, and (f) executing, when it is determined in the processing (b) that the bonus game will be executed, an effect based on the effect pattern data selected in the processing (e) in each of the unit games constituting the bonus game.

Namely, according to the above gaming machine, the bonus game is played after a total payout amount in the bonus game has been determined, and further, an effect is executed based on effect pattern data corresponding to the determined total payout amount. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an appropriate effect in accordance with the total payout amount to be offered can be executed, it is possible to avoid a condition where a payout expected from the effect is significantly different from an actual total payout amount. Therefore it becomes possible to prevent the player from being mistrustful of the game.

Moreover, since the effects depending on the total payout amount determined prior to execution of the bonus game can be executed as a series of effects over a plurality of the unit games, it is possible to gradually raise the expectation of the player for the results of the bonus game each time the unit game is played. It is thus possible to further increase amusement of the bonus game.

A third embodiment of the present invention provides a method for controlling a gaming machine having the following configuration.

Namely, the method for controlling the above-mentioned gaming machine includes the steps of (a) executing a normal game in which the symbols are rearranged and displayed to the display, (b) determining whether or not to execute a bonus game in which a unit game is played over a plurality of times, the unit game executing rearrangement and display of the symbols to the display and determining a payout based on the rearranged symbols or a combination of those symbols, (c) determining a total payout amount in the bonus game, and (d) executing, when it is determined in the step (b) that the bonus game will be executed, rearrangement and display of the symbols to the display in a manner that a payout amount offered in each of the unit games constituting the bonus game becomes equal to or less than a remaining payout amount obtained by subtracting a total amount of payout having been offered up to the time in the bonus game from the total payout amount determined in the step (c).

According to the above method for controlling a gaming machine, a total payout amount is determined in a bonus game in which a unit game is played over a plurality of times, the unit game executing rearrangement and display of the symbols to the display, and determining a payout based on the rearranged symbols or a combination of those symbols. Moreover, the rearrangement of the symbols is executed in a manner that a payout amount offered in each of the unit games constituting the bonus game becomes equal to or less than a remaining payout amount obtained by subtracting a total amount of payout having been offered up to the time in the bonus game from the above-determined total payout amount.

Namely, a total payout amount in the bonus game is determined prior to execution of the bonus game, while the arrangement of the symbols is controlled so that a total of the payout amounts of the respective unit games constituting the bonus game should not surpass the above-mentioned total payout amount. Therefore, it becomes possible to control the payout amount in the bonus game by adjusting a payout amount in each of the unit games with reference to the payout amount determined prior to execution of the bonus game. As a result, an effect which more accurately reflects the total payout amount in the bonus game can be performed.

Moreover, since the payout amount in the bonus game is controlled by making an adjustment in each of the unit games, data showing rearrangement patterns of the symbols in each of the unit games do not need to be stored. Therefore, it is possible to reduce the memory capacity to be used.

Furthermore, since the payout amount in the bonus game is controlled by making an adjustment in each of the unit games, the payout amount in the bonus game can be adjusted irrespective of the number of the unit games constituting the bonus game. Therefore, the number of the unit games can be variously changed.

Preferably, the above method for controlling a gaming machine further has the following configuration.

Namely, the step (d) is step of executing rearrangement and display of the symbols to the display in a manner that a payout amount offered in the last unit game in the bonus game becomes equal to the remaining payout amount.

According to the above gaming machine, the control to adjust the payout amount in the bonus game to be equal to the above-mentioned total payout amount is performed in the last unit game in the bonus game. By performing this control, the payout amount in the bonus game can be more accurately adjusted.

Preferably, the above method for controlling a gaming machine further has the following configuration.

Namely, the method further including the steps of (e) selecting one effect pattern data out of the effect pattern data corresponded to the total payout amount determined in the step (c), among the plurality of kinds of the effect pattern data stored in the memory corresponded to the total payout amount in the bonus game for use in executing an effect, and (f) executing, when it is determined in the step (b) that the bonus game will be executed, an effect based on the effect pattern data selected in the step (e) in each of the unit games constituting the bonus game.

According to the above method for controlling a gaming machine, the bonus game is played after a total payout amount in the bonus game has been determined, and further, an effect is executed based on effect pattern data corresponding to the determined total payout amount. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an appropriate effect in accordance with the total payout amount to be offered can be executed, it is possible to avoid a condition where a payout expected from the effect is significantly different from an actual total payout amount. Therefore it becomes possible to prevent the player from being mistrustful of the game.

Moreover, since the effects depending on the total payout amount determined prior to execution of the bonus game can be executed as a series of effects over a plurality of the unit games, it is possible to gradually raise the expectation of the player for the results of the bonus game each time the unit game is played. It is thus possible to further increase amusement of the bonus game.

### BRIEF DESCRIPTION OF THE DRAWINGS

FIG. 1 is a flowchart showing a subroutine of bonus game processing according to a first embodiment of the present invention.

FIG. 2 is a perspective view showing appearance of a slot machine according to the first embodiment of the present invention.

FIG. 3 is a pattern diagram showing columns of symbols to be displayed on respective display blocks.

FIG. 4 is a table showing the corresponding relations among a total payout amount, number of free games and rearrangement pattern data in a bonus game.

FIG. 5 is a view showing one example of images displayed to a lower-side image display panel in the first embodiment of the present invention.

FIG. 6 is a view showing one example of images displayed to a lower-side image display panel in the first embodiment of the present invention.

FIG. 7 is a block diagram showing an internal configuration of a slot machine shown in FIG. 2.

FIG. 8 is a flowchart showing a subroutine of the game execution processing according to the first embodiment of the present invention.

FIG. 9 is a flowchart showing a procedure for activation processing performed by a motherboard and a gaming board.

FIG. 10 is a flowchart showing a procedure for peripheral device initialization processing.

FIG. 11 is a flowchart showing a subroutine of activation processing executed by a central controller.

FIG. 12 is a flowchart showing a subroutine of symbol determination processing.

FIG. 13 is a view showing the relation among a plurality of kinds of prizes, establishment probability of each prize, and number of payouts.

FIG. 14 is a view showing one example of images displayed to a lower-side image display panel in a second embodiment of the present invention.

FIG. 15 is a flowchart showing a subroutine of bonus game processing according to the second embodiment of the present invention.

### DESCRIPTION OF THE EMBODIMENTS

An embodiment of the present invention is described based on drawings.

### First Embodiment

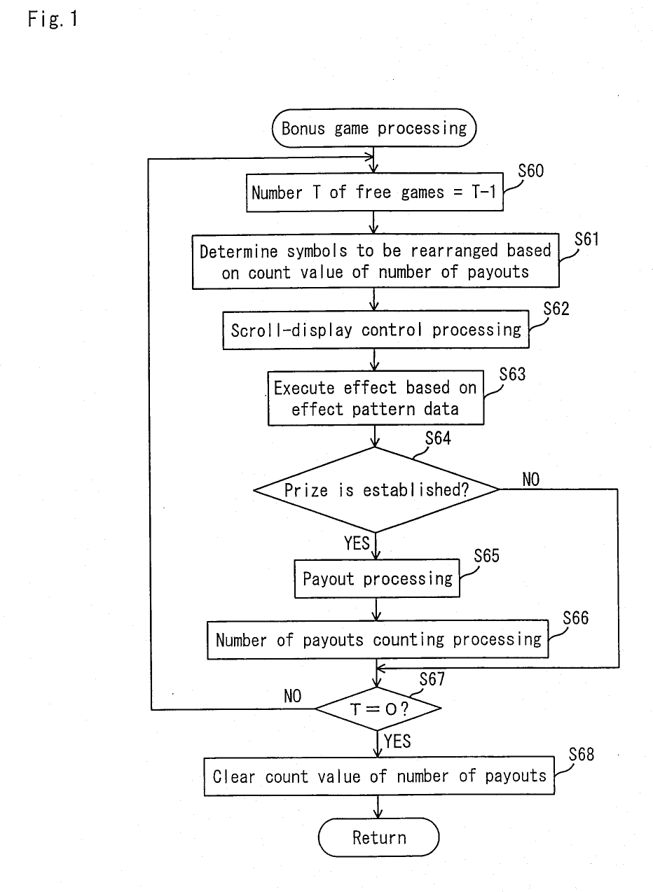

FIG. 1 is a flowchart showing a subroutine of game execution processing according to a first embodiment of the present invention.

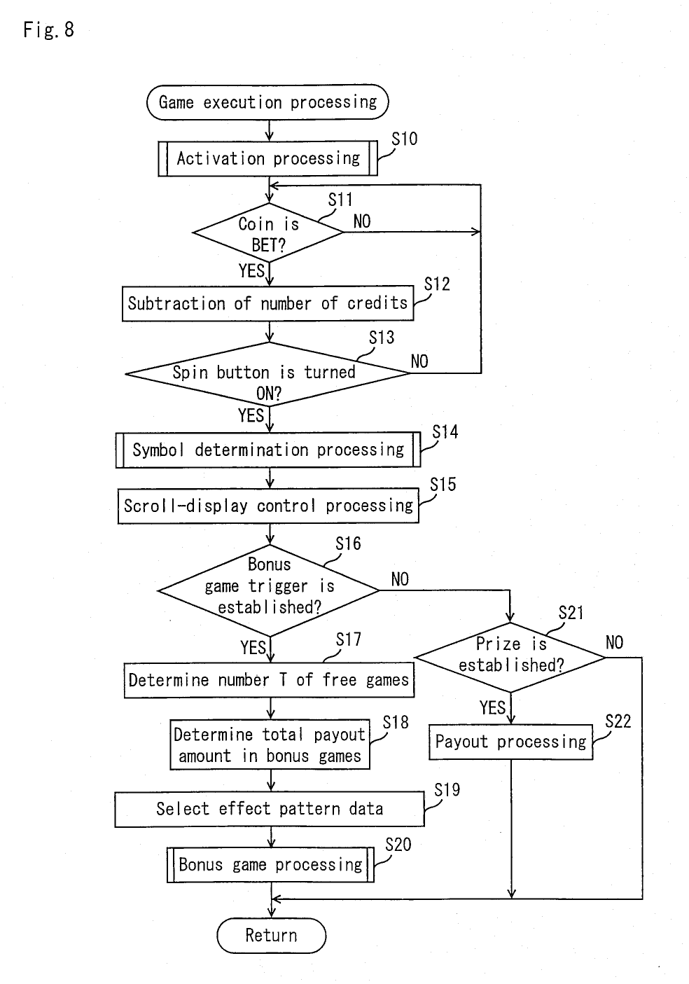

In the first embodiment, a bonus game is executed when a bonus game trigger is established in a normal game (game other than the normal game) (see FIG. 8). The bonus game consists of a plurality of times of free games. The free game is a game which can be played without additional insertion of game media by the player. The free game according to the present embodiment corresponds to the unit game of the present invention.

When it is determined that the bonus game will be executed, first, the number of times T of the free games to be executed in the bonus game is determined (see step S17 of FIG. 18). Then, a total payout amount in the bonus game is determined among a plurality of values by means of random numbers, and effect pattern data corresponding to the total payout amount is selected from a plurality of kinds of effect pattern data (see steps S18 and S19 in FIG. 8).

The bonus game processing is processing to execute the free games based on the number of times T of free games, the total payout amount in the bonus game, and the selected effect pattern data.

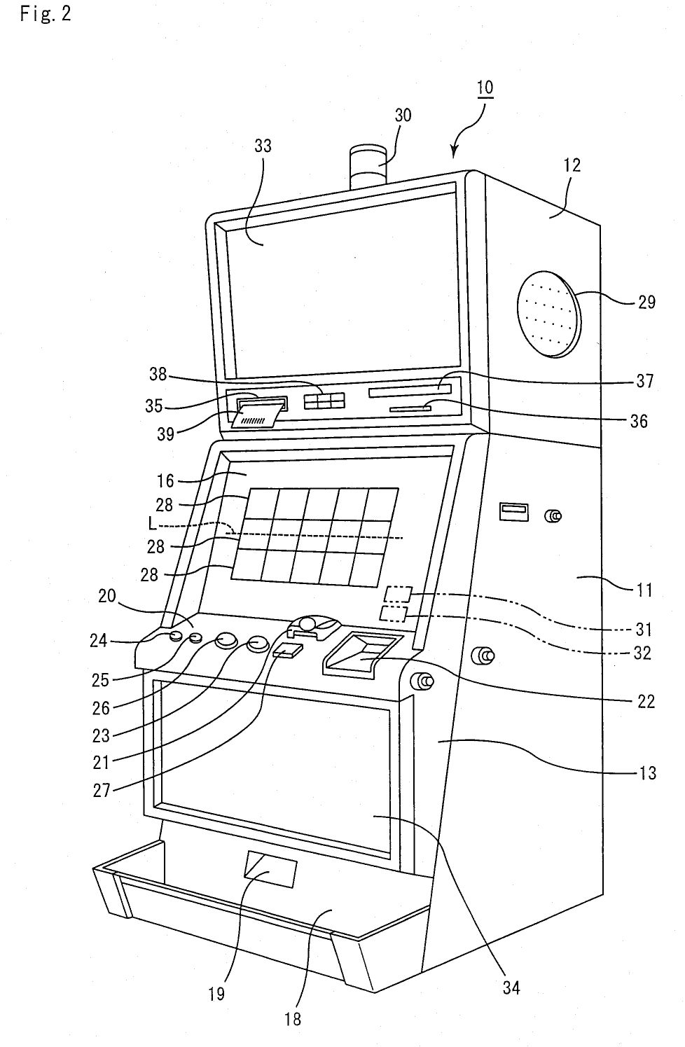

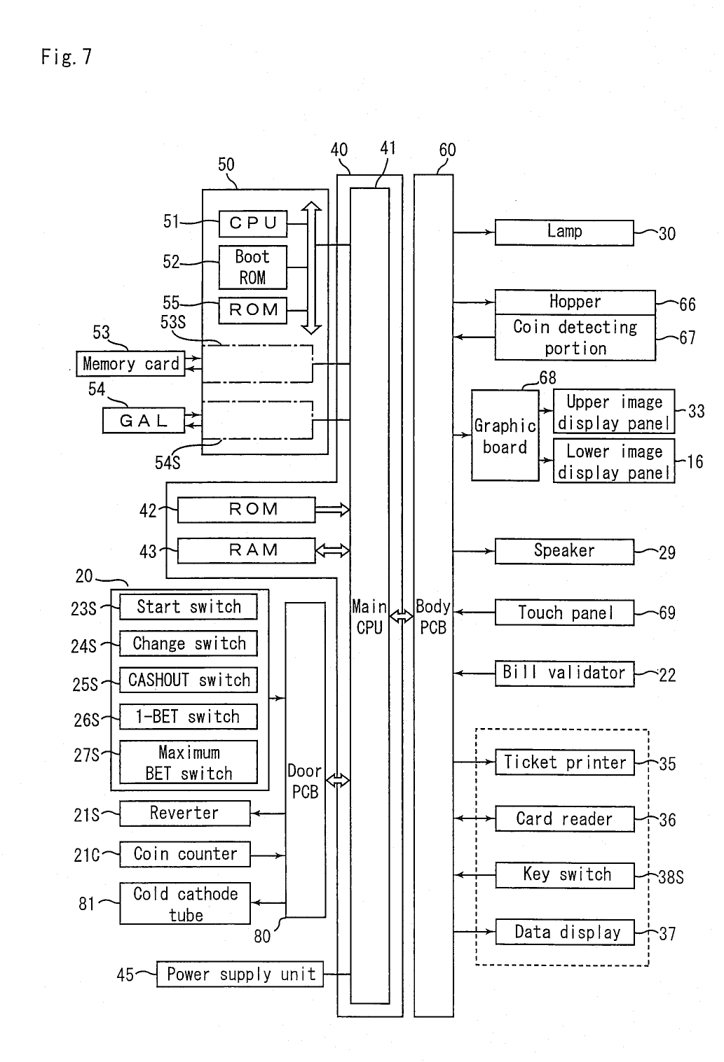

In the bonus game processing, first, a CPU 41 (see FIG. 7) installed in a slot machine 10 (see FIG. 2) executes processing of subtraction of 1 from the value of the number of times T of the free games (step S60).

Next, the main CPU 41 determines symbols to be rearranged to the display blocks 28 (see FIG. 2) of a lower-image display panel 16 (step S61) based on the count value of the number of payouts of coins as payout in the bonus game.

In the bonus game processing, the number of coins offered as payout is counted in each of free games (see step S66). The count value for the initial free game is 0, and the value is cumulatively accumulated during the bonus game.

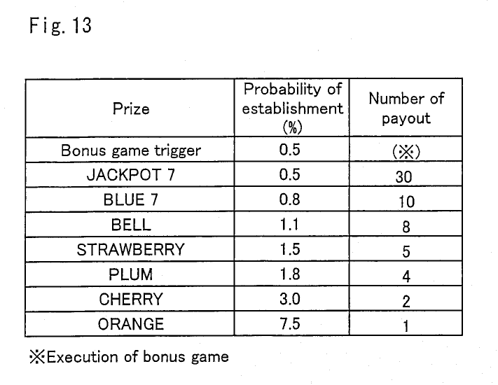

In the processing of the step S61, the main CPU 41 determines a combination of the symbols to be rearranged in a manner that the payout in the ongoing free game is equal to or less than a remaining payout amount obtained by subtracting the count value at the time from the above-mentioned total payout amount. As described later, payouts are determined depending on the combinations of symbols (see FIG. 13) rearranged on a winning line L (see FIG. 2), and from among the combinations, a combination in which the number of payouts is equal to or less than the remaining payout amount is selected. For example, when the total payout amount is 30 and the current count value of the number of payouts is 26, then the combination (prize) to be the object of selection is the combinations of “PLUM”, “CHERRY”, and “ORANGE” in which the number of payouts is 4 or less.

In the processing of step S61, the main CPU 41 determines whether the value T is 0 or not by referring to the result of subtraction of the number of times T of the free games in step S60. When the value of T is 0, namely, when the ongoing free game is the last free game, a combination of the symbols to be rearranged is determined in a manner that the number of payouts becomes equal to the remaining payout amount. For example, when the total payout amount is 30 and the current count value of the number of payouts is 26, and further the value of T is 0 (i.e. the ongoing free game is the last free game), then the combination of symbols (prize) is determined to be the combination of “PLUM” in which the number of payouts is 4.

Next, the main CPU 41 controls scrolling of the symbols on the display blocks 28 (step S62). Specifically, the main CPU 41 scroll-displays and stops the symbols on the display blocks 28 so that the prize determined in the step S61 is established in the free game.

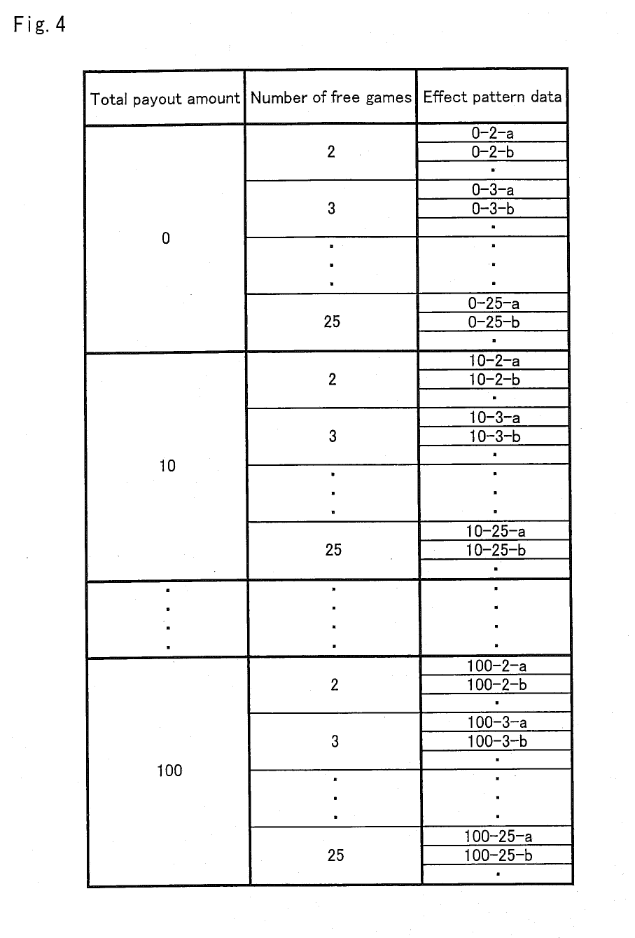

Subsequently, the main CPU 41 executes an effect based on the selected effect pattern data (step S63). The effect pattern data is data showing patterns of effects generated by images or sound in the bonus game. A plurality of kinds of effect pattern data are stored in the RAM 43 (see FIG. 7) in association with the total payout amount and the number of free games in the bonus game. The corresponding relation between the total payout amount and the number of free games in the bonus game with the effect pattern data will be detailed later by using FIG. 4.

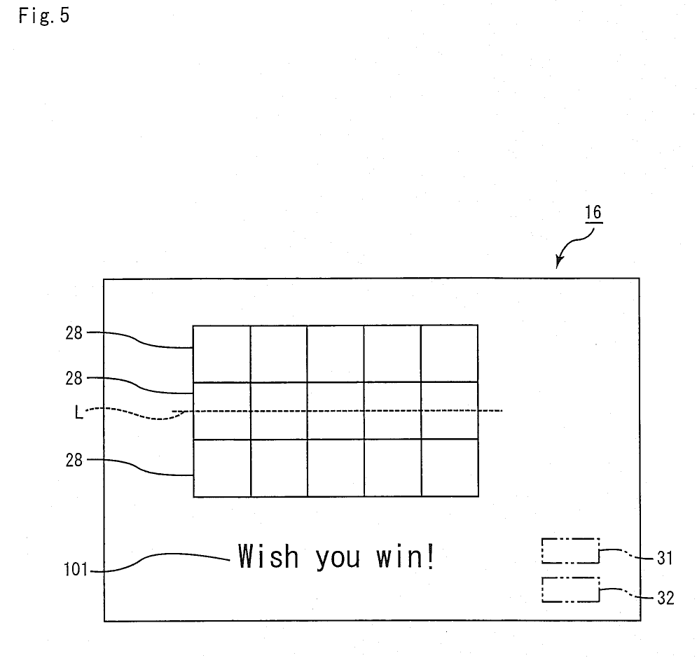

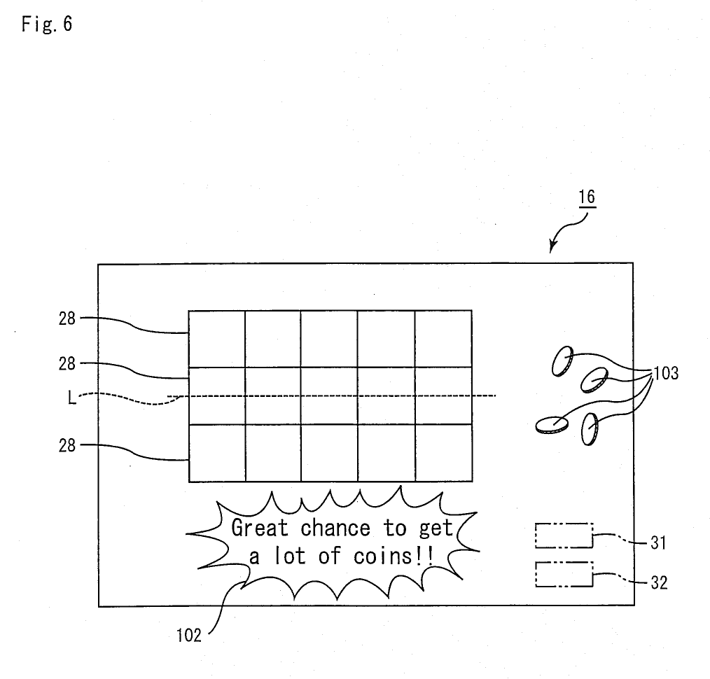

The processing of step S63 is executed specifically by generating an effect for gradually enhancing expectation of the player by outputting images or sounds as the free game turns go on, depending on the determined total payout amount (see FIG. 5 and FIG. 6).

Next, the main CPU 41 determines whether or not a prize has been established (step S64). When determining that a prize has been established, the main CPU 41 pays out coins depending on the prize (step S65), and executes processing of counting the number of payouts (step S66). In step S66, the main CPU 41 accumulates the number of paid-out coins to the count value stored in the RAM 43.

When determined in step S64 that any prize is not established (when determined the game is lost), or when processing of step S66 is executed, the main CPU 41 determines whether the value of the number of times T of free games is 0 or not (step S67). Namely, the main CPU 41 determines whether or not the free games have been played for a predetermined times.

When determining that the value of T is not 0, then the main CPU 41 returns the processing to step S60.

On the other hand, when determining that the value of T is 0, the main CPU 41 clears the count value of the number of payouts stored in the RAM 43 (step S68), and terminates the present subroutine.

Next, the configuration of the slot machine 10 according to the present embodiment is described.

FIG. 2 is a perspective view showing an outer appearance of the slot machine according to a first embodiment of the present invention.

In the slot machine 10, coins, bills, or electronic valuable information corresponding to those may be used as game media. However, in the present invention, the game media are not particularly restricted, and examples thereof may include medals, tokens, electronic money, and tickets. It is to be noted that the above ticket is not particularly limited, and examples thereof may include a ticket with a barcode as described later.

The slot machine 10 includes a cabinet 11, a top box 12 installed on the upper side of the cabinet 11, and a main door 13 provided at the front of the cabinet 11.

The main door 13 is provided with a lower-side image display panel 16 as a display. The lower-side image display panel 16 is provided with a transparent liquid crystal panel, and displays a variety of information on a game, effect images and the like. The lower-side image display panel 16 installed in the slot machine 10 is configured by a transparent crystal liquid panel, and displays fifteen display blocks 28 of five columns and three rows. One symbol is displayed to each of the display blocks 28. Namely, three symbols are displayed on each symbol column. Further, on the lower-side image display panel 16, one winning line L is formed horizontally across the five display blocks 28 displayed on the central row. The winning line L defines a combination of symbols. When a combination of symbols rearranged on the winning line L is a prescribed combination, a payout is offered in accordance with the combination and the number of inserted game media (number of BETs).

Further, a number-of-credits display portion 31 and a number-of-payouts display portion 32 are set on the lower-side image display panel 16. In the number-of-credits display portion 31, the number of credits at the moment is displayed by an image. In the number-of-payouts display portion 32, the number of coins to be paid out is displayed by an image.

Moreover, although not shown, a touch panel 69 is provided at the front of the lower-side image display panel 16. The player can operate the touch panel 69 to input a variety of commands.

At a lower part of the lower-side image display panel 16, there are provided a control panel 20 including a plurality of buttons 23 to 27 with which the player input commands in accordance of the game progress, a coin receiving slot 21 from which coins are accepted into the cabinet 11, and a bill validator 22.

The control panel 20 is provided with the spin button 23, a change button 24, a CASHOUT button 25, the 1-BET button 26, and the maximum BET button 27. The spin button 23 is used for inputting a command to start scroll of symbols. The change button 24 is used in making a request for money exchange to an attendant of gaming facilities. The CASHOUT button 25 is used for inputting a command to pay out credited coins to the coin tray 18.

The 1-BET button 26 is used for inputting a command to bet one coin in a game out of credited coins. The maximum BET button 27 is used for inputting a command to bet the maximum number of coins bettable in one game (50 coins in the present embodiment).

The bill validator 22 discriminates whether a bill is true or not, and also accepts a true bill into the cabinet 11. It is to be noted that the bill validator 22 may be configured so as to read a ticket 39 with a barcode described below. Buried glass 34 on which a character of the slot machine 10 or the like is drawn is provided on the lower front of the main door 13, namely under the control panel 20.

The upper-side image display panel 33 is provided at the front of the top box 12. The upper-side image display panel 33 is provided with a liquid crystal panel to which, for example, an image representing introduction of contents of a game and explanation of a rule of the game.

Further, the top box 12 is provided with a speaker 29. At a lower side of the upper image display panel 33, there are provided a ticket printer 35, a card reader 36, a data display 37, and a key pad 38. The ticket printer 35 prints a barcode on a ticket as coded data of the number of credits, a date, an identification number of the slot machine 10, etc., and outputs the ticket as the ticket 39 with a barcode. The player can make another slot machine read the ticket 39 with a barcode to play a game on the slot machine, or exchange the ticket 39 with a barcode with a bill or the like at a prescribed place (e.g. cashier in a casino) of the gaming facilities.

The card reader 36 reads data from a smart card and writes data into the smart card. The smart card is a card owned by the player, and for example stores data for identifying the player and data on a history of games played by the player. The smart card may store data corresponding to coins, bills or credits. Further, a magnetic stripe card may be employed in place of the smart card. The data display 37 is configured by a fluorescent display and the like, and displays, for example, data read by the card reader 36 and data inputted by the player through the key pad 38. The key pad 38 is used for inputting a command and data on ticket issuance and the like.

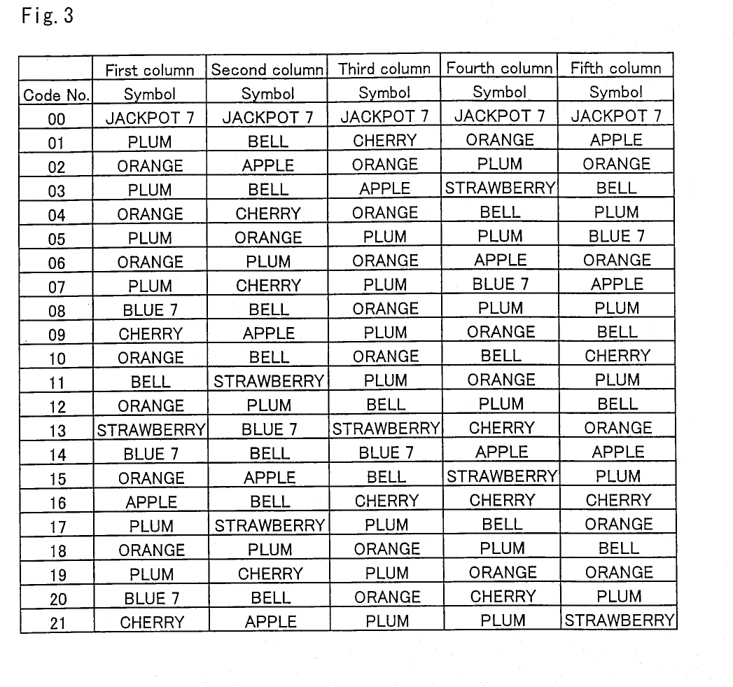

FIG. 3 is a pattern diagram showing columns of symbols to be displayed on each of display blocks.

As described above, the fifteen display blocks 28 of five columns and three rows are displayed on the lower-side image display panel 16, and one symbol is displayed on each of the display blocks 28.

As shown in FIG. 3, on the five symbol columns of the display blocks 28, columns of a total 22 symbols consisting of code numbers “00” to “21” are scrolled. Each of the symbol columns is made up of a combination of symbols of “JACKPOT 7”, “BLUE 7”, “BELL”, “STRAWBERRY”, “PLUM”, “CHERRY”, “ORANGE”, and “APPLE”.

When five of symbols “JACKPOT 7”, “BLUE 7”, “BELL”, “STRAWBERRY”, “PLUM”, “CHERRY”, and “ORANGE” are rearranged on the winning line L, a previously set payout is offered (see FIG. 13).

The symbol of “APPLE” is a bonus game trigger (symbol for shifting to a bonus game). When five “APPLE” symbols are rearranged on the winning line L, the game can be shifted to the bonus game. In the present embodiment, the bonus game consists of free games (game where a player can play a prescribed number of games without betting game media).

When the spin button 23 is pressed down after the 1-BET button 26 or the maximum BET button 27 is pressed, symbols displayed on the display blocks 28 are scroll-displayed downward. After the lapse of prescribed time, symbols are rearranged. Further, a variety of prizes are previously set based on the combinations of symbols (see FIG. 13), and when a combination of symbols corresponding to a prize stop on the winning line L, a payout in accordance with the prize is offered. Further, when the bonus game trigger is established, the bonus game is generated.

It should be noted that, although the case was described in the present embodiment where symbols displayed on the display blocks 28 are automatically rearranged after the lapse of prescribed time from the screen-display of the symbols. However, in the present invention, a condition for stopping symbols is not particularly limited. For example, the slot machine 10 may be provided with a stop button, and symbols may be rearranged when the stop button is pressed down.

Further, although the case where a prize is determined based on a combination of symbols rearranged on the winning line L is described in the present embodiment, a prize may be decided based on the kind or the number of symbols rearranged on the display in the present invention.

Next, effect pattern data is described.

FIG. 4 is a table showing the corresponding relations among a total payout amount, number of free games and effect pattern data in a bonus game.

As shown in FIG. 4, a plurality of kinds of effect pattern data are corresponded to the total payout amounts (0 to 100) and the numbers of free games (2 to 25) in the bonus game. For example, as effect pattern data that correspond to the case of the total payout amount being ten coins and the number of free games being three, different kinds of data, 10-3-a, 10-3-b, are prepared.

When the bonus game trigger is established and the number of free games and the total payout amount are determined in the gaming execution processing, one effect pattern data is selected out of a plurality of kinds of effect pattern data (10-3-a, 10-3-b, etc.) corresponding to the determined number of free games and the determined total payout amount.

Next, images displayed to the lower-side image display panel 16 in the slot machine 10 are described. FIGS. 5 and 6 are views each showing an example of images displayed to the lower-side image display panel during a bonus game in which the total payout amount has been determined to be a relatively large value.

FIG. 5 shows an example of images displayed in early turns of a plurality of free games in the bonus game. An image 101 prompting expectation of the player is displayed on the lower side of the lower-side image display panel 16.

As the game turns go on, an image as shown in FIG. 6 is displayed.

As shown in FIG. 6, an image 102 suggesting a high possibility of the player acquiring a large payout is displayed on the lower side of the lower-side image display panel 16, and an image 103 showing coins as the payout are displayed on the right side of the lower-side image display panel 16.

As thus described, in the present embodiment, in accordance with the total payout amount of the bonus game, effects to raise the expectation of the player are gradually executed as the free games proceed.

FIG. 7 is a block diagram showing an internal configuration of the gaming machine shown in FIG. 2.

A gaming board 50 is provided with a CPU (central processing unit) 51, a ROM 55, a boot ROM 52, a card slot 53S corresponding to a memory card 53, and an IC socket 54S corresponding to a GAL (generic array logic) 54, which are mutually connected through an internal bus.

The memory card 53 is configured by a nonvolatile memory such as CompactFlash (registered trade mark), and stores a game program. The game program includes a symbol determination program. The symbol determination program is a program for determining symbols (code No. corresponding to symbols) to be rearranged on the display blocks 28.

Further, the card slot 53S is configured so as to be capable of inserting and pulling out the memory card 53, and connected to the motherboard 40 through an IDE bus. Therefore, the kind and contents of a game played on the slot machine 10 can be changed by pulling out the memory card 53 from the card slot 53S, writing another game program into the memory card 53, and inserting the memory card 53 into the card slot 53S. The game program includes a program relating to game progress. Further, the game program includes image data and sound data to be outputted during the game.

The CPU 51, the ROM 55 and the boot ROM 52 which are mutually connected through the internal bus are connected to the motherboard 40 through a PCI bus. The PCI bus transmits a signal between the motherboard 40 and the gaming board 50, and supplies power from the motherboard 40 to the gaming board 50.

The motherboard 40 is configured using a commercially available general-purpose motherboard (print wiring board mounted with fundamental components of a personal computer), and includes a main CPU 41, a ROM (read only memory) 42, and a RAM (random access memory) 43. The motherboard 40 corresponds to the controller in the present invention.

The ROM 42 is configured by a memory device such as a flash memory, and stores a program such as a BIOS (basic input/output system) to be executed by the main CPU 41 and permanent data. When the BIOS is executed by the main CPU 41, processing of initializing prescribed peripheral devices is performed concurrently with start of processing of downloading the game program stored in the memory card 53 through the gaming board 50. It should be noted that in the present invention, contents of the ROM 42 may be rewritable or not rewritable.

The RAM 43 stores data and a program to be used in actuation of the main CPU 41. Further, the RAM 43 is capable of storing a game program.

Further, the RAM 43 stores the number of credits, data showing a count value of the number of payouts, effect pattern data, and the like. The RAM 43 corresponds to the memory in the present invention.

Moreover, the motherboard 40 is connected with a later-described main body PCB (printed circuit board) 60 and a door PCB 80 through respective USBs. Further, the motherboard 40 is connected with a power source unit 45.

The main body PCB 60 and the door PCB 80 are connected with an instrument and a device that generate an input signal to be inputted into the main CPU 41 and with an instrument and a device, operations of which are controlled by a control signal outputted from the main CPU 41. The main CPU 41 executes the game program stored in the RAM 43 based on the input signal inputted into the main CPU 41 to perform prescribed computational processing and store the result into the RAM 43, or to transmit a control signal to each instrument and device as processing of controlling each instrument and device.

The main body PCB 60 is connected with a lamp 30, the hopper 66, a coin detecting portion 67, a graphic board 68, the speaker 29, the touch panel 69, the bill validator 22, the ticket printer 35, the card reader 36, a key switch 38S and the data display 37. The lamp 30 is lit up in a prescribed pattern based on the control signal outputted from the main CPU 41.

The hopper 66 is installed inside the cabinet 11, and pays out a prescribed number of coins from the coin payout exit 19 to the coin tray 18 based on the control signal outputted from the main CPU 41. The coin detecting portion 67 is provided inside the coin payout exit 19, and outputs an input signal to the main CPU 41 in the case of detecting payout of the prescribed number of coins from the coin payout exit 19.

The graphic board 68 controls display of images on the upper-side image display panel 33 and the lower-side image display panel 16 based on the control signal outputted from the main CPU 41. On each of the display blocks 28 of the lower-side image display panel 16, a background color decided by selection of a random number and a symbol scrolled or stopped is displayed. The number of credits stored in the RAM 43 is displayed to the number-of-credits display portion 31 of the lower-side image display panel 16. Further, the number of paid-out coins is displayed in the number-of-payouts display portion 31 of the lower-side image display panel 16.

The graphic board 68 includes a VDP (video display processor) for generating image data based on the control signal outputted from the main CPU 41, a video RAM for temporarily storing image data generated by the VDP, and the like. It is to be noted that the image data used in generation of image data by the VDP is included in the game program read from the memory card 53 and stored into the RAM 43.

The bill validator 22 discriminates whether a bill is true or not, and accepts a true bill into the cabinet 11. Upon acceptance of the true bill, the bill validator 22 outputs an input signal to the main CPU 41 based on an amount of the bill. The main CPU 41 stores the number of credits in accordance with the bill amount transmitted by the input signal into the RAM 43.

The ticket printer 35 prints on a ticket a barcode formed by encoding data such as the number of credits stored in the RAM 43, a date, and an identification number of the slot machine 10 based on the control signal outputted from the main CPU 41, and outputs the ticket as the ticket 39 with a barcode.

The card reader 36 reads data from the smart card and transmits the read data to the main CPU 41, or writes data into the smart card based on the control signal from the main CPU 41. The key switch 38S is provided on the key pad 38, and when the key pad 38 is operated by the player, a prescribed input signal is outputted to the main CPU 41. The data display 37 displays data read by the card reader 36 and data inputted by the player through the keypad 38, in accordance with the control signal outputted from the main CPU 41.

The door PCB 80 is connected with a control panel 20, a reverter 21S, a coin counter 21C, and a cold cathode tube 81. The control panel 20 is provided with a start switch 23S corresponding to the spin button 23, a change switch 24S corresponding to the change button 24, a CASHOUT switch 25S corresponding to the CASHOUT button 25, the 1-BET switch 26S corresponding to the 1-BET button 26, and the maximum BET switch 27S corresponding to the maximum BET button 27. The respective switches 23S to 27S output input signals to the main CPU 41 when the corresponding buttons 23 to 27 are operated by the player.

The coin counter 21C is provided inside the coin receiving slot 21, and discriminate whether coins inserted into the coin receiving slot 21 by the player are true or not. Coins other than a true coin are discharged from the coin payout exit 19. Further, the coin counter 21C outputs an input signal to the main CPU 41 when a true coin is detected.

The reverter 21S operates based on the control signal outputted from the main CPU 41, and distributes a coin recognized by the coin counter 21C as the true coin into a cash box (not shown) installed inside the slot machine 10 or to the hopper 66. Namely, when the hopper 66 is filled with coins, the true coin is distributed to the cash box by the reverter 21S. On the other hand, when the hopper 66 is not filled with coins, the true coin is distributed to the hopper 66. The cold cathode tube 81 functions as a backlight installed on the rear face side of the lower-side image display panel 16 and the upper-side image display panel 33, and lit up based on the control signal outputted from the main CPU 41.

Next, processing performed on the slot machine 10 are described.

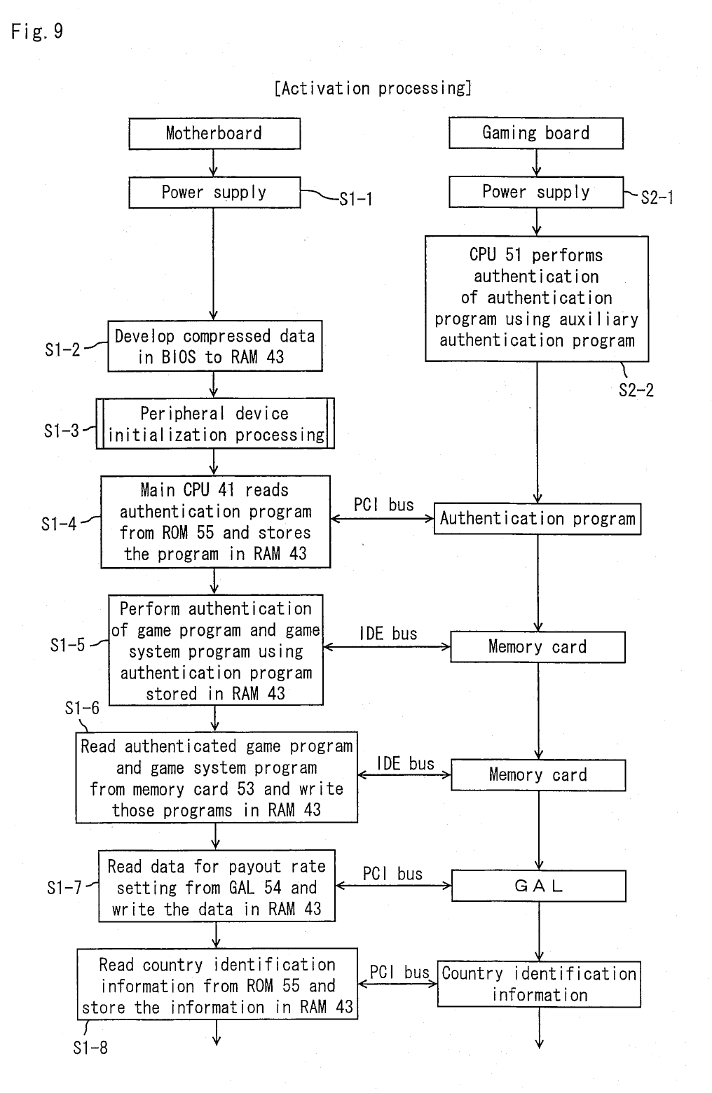

FIG. 8 is a flowchart showing a subroutine of the game execution processing according to the first embodiment of the present invention. In the game execution processing, first, the main CPU 41 performs activation processing (see step S10) by a motherboard 40 and a gaming board 50. The activation processing will be detailed later by using FIGS. 9 to 11.

Next, the main CPU 41 determines whether or not coins have been betted (step S11). In this processing, the main CPU 41 determines whether or not an input signal outputted from a 1-BET switch 26S has been received when a 1-BET button 26 is operated, or whether or not an input signal outputted from a maximum BET switch 27S has been received when a maximum BET button 27 is operated. When determining that coins have not been betted, the main CPU 41 returns the processing to step S11.

On the other hand, when determining in step S11 that coins have been betted, the main CPU 41 performs processing of subtraction from the number of credits stored in the RAM 43 in accordance with the number of betted coins (step S12). It is to be noted that, when the number of betted coins is larger than the number of credits stored in the RAM 43, the main CPU 41 returns the processing to step S11 without performing the processing of subtraction from the number of credits stored in the RAM 43. Moreover, when the number of betted coins exceeds an upper limit value bettable in one game (50 in the present embodiment), the main CPU 41 advances the processing to step S13 without performing the processing of subtraction from the number of credits stored in the RAM 43.

Next, in step S13, the main CPU 41 determines whether or not a spin button 23 has been turned ON. In this processing, the main CPU 41 determines whether or not the main CPU 41 has received an input signal that is outputted from a start button 23S when the spin button 23 is pressed down.

When determining that the spin button 23 has not been turned ON, the main CPU 41 returns the processing to step S1. It is to be noted that, when the spin button 23 is not turned ON (e.g. when a command indicating end of the game is inputted without turning-on of the spin button 23), the main CPU 41 cancels the subtraction result in step S12.

On the other hand, when determining in step S13 that the spin button 23 has been turned ON, the main CPU 41 shifts the processing to step S14.

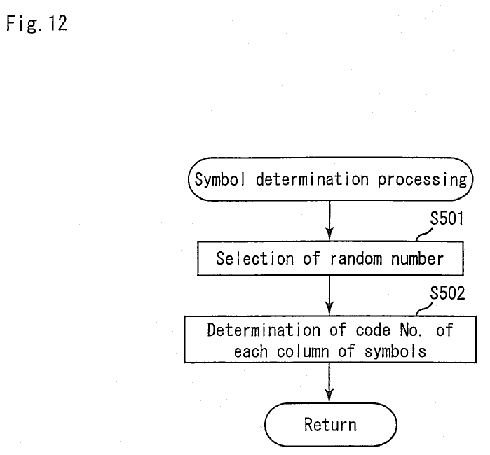

Next, the main CPU 41 performs symbol determination processing (step S14). In this symbol determination processing, the main CPU 41 executes a symbol determination program stored in the RAM 43, to decide a code No. at stopping of symbols. Thereby, a combination of symbols to be rearranged is determined. This processing is detailed later using FIGS. 12 and 13. It should be noted that the case was described in the present embodiment where a combination of symbols to be rearranged are determined, thereby one prize out of a plurality of kinds of prizes is decided. However, in the present invention, it may be possible, for example, that one prize selected out of a plurality of prizes may be decided first, followed by determination of a combination of symbols to be rearranged.

Next, the main CPU 41 performs scroll-display control processing (step S15). This processing is processing of stopping scroll-display of each display block 28 such that a combination of symbols corresponding to the prize decided in step S14 is rearranged on a winning line L after scroll-display of symbols has been started.

Next, the main CPU 41 determines whether or not a bonus game trigger has been established, namely whether or not five “APPLE” symbols are rearranged on the winning line L (step S16).

When determining that the bonus game trigger has been established, the main CPU 41 determines the number of times T of free games in the bonus game by means of random numbers (step S17). The range of the value T is from 2 to 25.

Next, the main CPU 41 determines a total payout amount in the bonus game, namely T times of free games, out of 0 to 100 coins by means of random numbers (step S18).

Next, with reference to a data table stored in the RAM 43, the main CPU 41 selects effect pattern data for use in executing an effect in the bonus game based on the number of times T of free games and the total payout amount in the bonus game (step S19).

Next, the main CPU 41 reads a program for performing a bonus game from the RAM 43, to execute bonus game processing (step S20). In the bonus game processing, an effect based on the effect pattern data selected in step S19 is executed over the T times of free games. Since the bonus game processing has already been described using FIG. 1, a detailed description thereof is omitted here.

When determining in step S16 that the bonus game trigger has not been established, the main CPU 41 determines whether or not a prize has been established (step S21). When determining that a prize has been established, the main CPU 41 pays out coins in accordance with the number of inserted game media and the prizes (step S22).

In the case of reserving coins, the main CPU 41 performs processing of addition to the number of credits stored in the RAM 43. On the other hand, in the case of paying out coins, the main CPU 41 transmits a control signal to a hopper 66 to pay out a prescribed number of coins.

When executing the processing of step S20 or S22, or determining that any prize has not been established in step S22 (determining that the game is lost), the main CPU 41 completes the present subroutine.

It is to be noted that the game played during execution of the processing of steps S11 to S16, S21 and S22 corresponds to the normal game in the present invention.

FIG. 9 is a flowchart showing a procedure for the activation processing.

This activation processing is processing performed by the motherboard 40 and the gaming board 50. It is to be noted that the memory card 53 is inserted in the card slot 53S in the gaming board 50, and the GAL 54 is installed in the IC socket 54S.

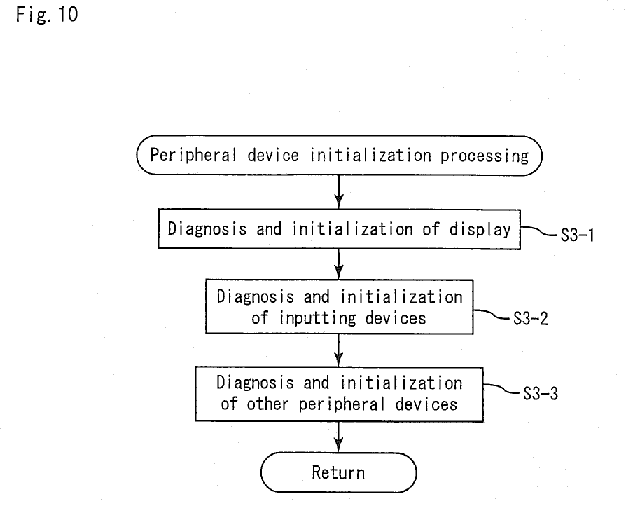

First, when the power switch is turned ON (power is turned ON) in the power source unit 45, the motherboard 40 and the gaming board 50 are activated (steps S1-1, S2-1). When the motherboard 40 and the gaming board 50 are activated, separate processing are respectively performed in parallel. Namely, in the gaming board 50, the CPU 51 reads an auxiliary authentication program stored in the boot ROM 52, and in accordance with the read auxiliary authentication program, the CPU 51 performs auxiliary authentication to check and verify that the authentication program was not previously falsified before being taken into the motherboard 40 (Step S2-2). Meanwhile, in the motherboard 40, the main CPU 41 executes the BIOS stored in the ROM 42, and develops compressed data incorporated in the BIOS to the RAM 43 (step S1-2). The CPU 41 then executes the BIOS developed to the RAM 43, and diagnoses and initializes a variety of peripheral devices (step S1-3). The processing of step S1-3 will be detailed later using FIG. 10.

Since the main CPU 41 is connected with the ROM 55 of the gaming board 50 through the PCI bus, the main CPU 41 reads the authentication program stored in the ROM 55, and also performs processing of storing the read authentication program into the RAM 43 (step S1-4). At this time, the main CPU 41 obtains a checksum by ADDSUM system (standard checking function) in accordance with the function of the standard BIOS of the BIOS, and makes the RAM 43 store the authentication program while performing processing of checking whether or not the storage is performed without an error.

Next, after checking what is connected with an IDE bus, the main CPU 41 makes access to the memory card 53 inserted in the card slot 53S through the IDE bus, and reads a game program and a game system program from the memory card 53. In this case, the main CPU 41 reads data constituting the game program and the game system program in every four bytes. Subsequently, the main CPU 41 performs authentication to check and verify that the read authentication program was not previously falsified in accordance with the authentication stored in the RAM 43 (step S1-5). When the authentication processing is normally completed, the main CPU 41 makes the RAM 43 write and store the game program and the game system program, which were the objects to be authenticated (which have been authenticated) (step S1-6). Next, the main CPU 41 makes access to the GAL 54 connected to the IC socket 54S through the PCI bus, reads data for payout rate setting from the GAL 54, and makes the RAM 43 write and store the data (step S1-7). The main CPU 41 then reads country identification information stored in the ROM 55 in the gaming board 50 through the PCI bus, and further makes the RAM 43 store the read country identification data (step S1-8).

After performing the foregoing processing, the main CPU 41 sequentially reads and executes the game program and the game system program to advance the game.

FIG. 10 is a flowchart showing a procedure for peripheral device initialization processing.

First, the main CPU 41 diagnoses and initializes the display (step S3-1). In this processing, the main CPU 41 transmits a request signal to the graphic board 68, and determines whether or not the main CPU 41 has received a prescribed response signal, while clearing a prescribed storage region, and the like.

Next, the main CPU 41 diagnoses and initializes a variety of input devices (step S3-2). In this processing, the main CPU 41 transmits a request signal to the input devices such as the start switch 23S, the change switch 24S, the CASHOUT switch 25S, the 1-BET switch 26S, the maximum BET switch 27S, and the touch panel 69, and determines whether or not the main CPU 41 has received a prescribed response signal.

Next, the main CPU 41 diagnoses and initializes the other peripheral devices connected to the main CPU 41 (step S3-3). Thereafter, the main CPU 41 completes the present subroutine.

In the present embodiment, the case of the slot machine 10 being a standalone type was described. However, in the present invention, a plurality of slot machines may be connected to a central controller through a network so that the plurality of slot machines may be controlled by the central controller.

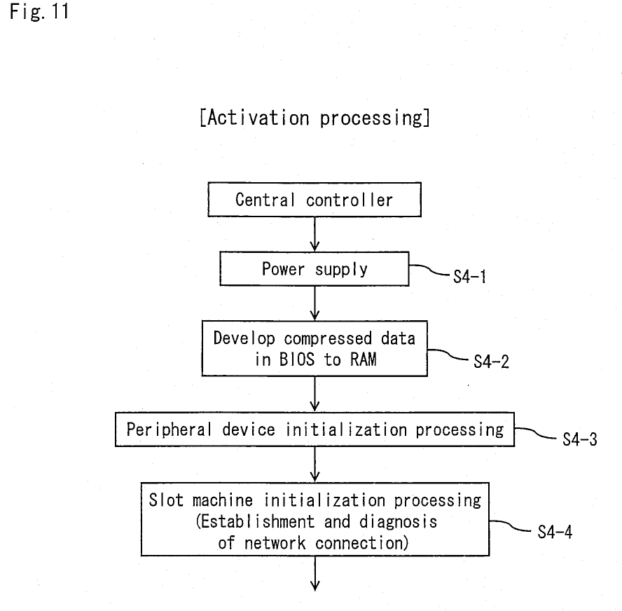

FIG. 11 is a flowchart showing a subroutine of activation processing executed by the central controller.

First, when a power switch is turned ON (power is turned ON) in a power source unit, a motherboard is activated (step S4-1).

In the motherboard, a CPU executes a BIOS stored in a ROM, and develops compressed data incorporated in the BIOS to a RAM (step S4-2). The CPU then executes the BIOS developed to the RAM, and diagnoses and initializes a variety of peripheral devices such as a display (step S4-3).

Next, the CPU executes initialization processing on each slot machine. In this processing, the CPU establishes network connection of the central controller with each slot machine, while diagnosing whether or not the network is functioning properly.

After performing the foregoing processing, the CPU reads and executes the game control program to control the progress of a game executed by the plurality of slot machines.

FIG. 12 is a flowchart showing a subroutine of the symbol determination processing that is called and executed in step S14 of the subroutine shown in FIG. 8. This processing is performed when the main CPU 41 executes the symbol determination program stored in the RAM 43.

First, the main CPU 41 executes a program for random number generation included in the symbol determination program to select a random number value corresponding to each of the symbol columns out of the range of numeric values of 0 to 255 (step S501). In the present embodiment, the case of generating random numbers on the program (the case of using so-called software random numbers) is described. However, in the present invention, a random number generator may be previously provided, and random numbers may be extracted from the random number generator (so-called hardware random numbers may be used).

Next, based on selected five random number values, the main CPU 41 decides code No. of each symbol column (see FIG. 3) (step S502). The code No. of each symbol column corresponds to the code No. of a symbol to be rearranged on the winning line L. The main CPU 41 determines a prize by determining the code No. of each symbol column. For example, when the main CPU 41 determines the code No. of the symbols to be “00”, “00”, “00”, “00”, and “00”, it means that the main CPU 41 determines the prize to be “JACKPOT 7”.

Here, prizes in the present embodiment are described.

FIG. 13 is a diagram showing the relation of a plurality of kinds of prizes, and establishment probabilities and the numbers of payouts for each of the prizes.

When five symbols of “APPLE” are rearranged on the winning line L and the bonus game trigger is won, the bonus game is generated.

Further, when five symbols of “JACKPOT 7” are rearranged on the winning line L, 30 coins are paid out. Similarly, when five symbols of “BLUE 7”, “BELL”, “STRAWBERRY”, “PLUM”, “CHERRY”, or “ORANGE” are rearranged on the winning line L, payouts are made in amounts corresponding to prizes for the respective combinations.

As mentioned above, the slot machine 10 according to the first embodiment of the present invention has the lower-image display panel 16 (display) capable of arranging symbols. Moreover, the slot machine 10 has the motherboard 40 (controller) programmed to execute the following processing of (a) executing a normal game in which the symbols are rearranged and displayed to the lower-image display panel 16, (b) determining whether or not to execute a bonus game in which a free game is played over a plurality of times, the free game executing rearrangement and display of the symbols to the lower-image display panel 16 and determining a payout based on the rearranged symbols or a combination of those symbols, (c) determining a total payout amount in the bonus game, and (d) executing, when it is determined in the processing (b) that the bonus game will be executed, rearrangement and display of the symbols to the lower-image display panel 16 in a manner that a payout amount offered in each of the free games constituting the bonus game becomes equal to or less than a remaining payout amount obtained by subtracting a total amount of payout having been offered up to the time in the bonus game from the total payout amount determined in the processing (c).

Namely, on the above slot machine 10, a total payout amount in the bonus game is determined prior to execution of the bonus game, while the arrangement of the symbols is controlled so that a total of the payout amounts of the respective free games constituting the bonus game should not surpass the above-mentioned total payout amount. Therefore, it becomes possible to control the payout amount in the bonus game by adjusting a payout amount in each of the free games with reference to the payout amount determined prior to execution of the bonus game. As a result, an effect which more accurately reflects the total payout amount in the bonus game can be performed.

Moreover, since the payout amount in the bonus game is controlled by making an adjustment in each of the free games, data showing rearrangement patterns of the symbols in each of the free games do not need to be stored. Therefore, it is possible to reduce the memory capacity to be used.

Further, since the payout amount in the bonus game is controlled by making an adjustment in each of the free games, the payout amount in the bonus game can be adjusted irrespective of the number of the free games constituting the bonus game. Therefore, the number of the free games can be variously changed.

Furthermore, according to the slot machine 10, control of the payout amount in the bonus game so as to be equal to the above-mentioned total payout amount is carried out in the last game of the free games constituting the bonus game. By performing this control, it becomes possible to more accurately adjust the payout amount in the bonus game.

It is to be noted that, although the above description on the present embodiment has discussed the case where the determination on whether or not the ongoing free game is the last free game is made by counting (subtracting) the number of times of the free games, it is also possible in the present invention to employ a configuration in which, for example, determination on whether or not to set the ongoing free game as the last game is made in each of the free games.

Furthermore, according to the slot machine 10 bonus game is played after a total payout amount in the bonus game has been determined, and further, an effect is executed based on effect pattern data corresponding to the determined total payout amount. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an effect in accordance with the total payout amount to be offered can be executed, it becomes possible to avoid a condition where a payout expected from the effect is significantly different from the actual total payout amount, and therefore it becomes possible to prevent the player from being mistrustful of the game.

Moreover, since an effect in accordance with the total payout amount determined prior to execution of the bonus game can be executed as a series of effects over a plurality of free games, it is possible to gradually raise the expectation of the player for the results of the bonus game. It is thus possible to further increase amusement of the bonus game.

### Second Embodiment

In the following description of a second embodiment of the present invention, the constituent elements corresponding to those of the slot machine 10 of the first embodiment are marked with the same symbols as those used in the first embodiment.

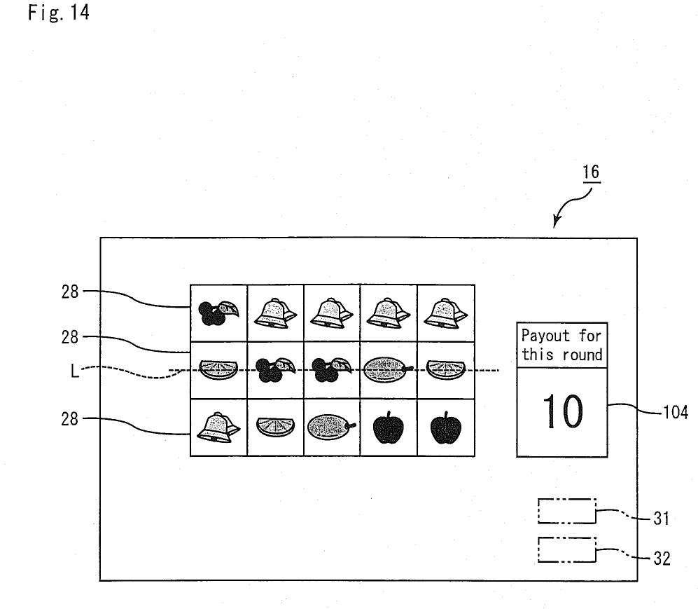

FIG. 14 is a view showing one example of images displayed to the lower-side image display panel during a bonus game according to the second embodiment of the present invention.

In the second embodiment, a payout is determined in each of the free games in the bonus game irrespective of the rearrangement of the symbols. Specifically, the payout amount of the ongoing free game is determined so as to be equal to or less than a remaining payout amount obtained by subtracting the payout amount having been offered up to the point in the bonus game (count value of the number of payouts) from the total payout amount determined prior to execution of the bonus game. Then, after rearrangement of the symbols, the determined payout amount is notified by images.

As shown in FIG. 14, the symbols are rearranged and displayed to each of the display blocks 28, and on the right side of the display blocks 28 is displayed a payout reel image 104 showing the payout amount to be offered (number of coin-outs) in the ongoing free game. In each of the free games, upon rearrangement of the symbols, the payout reel is scrolled and stopped. The payout shown by the payout reel image is a payout equal to or less than the remaining payout amount that is determined based on the count value of the number of payouts and the total payout amount, and the payout does not depend on the combination of the rearranged symbols.

Next, processing executed in the slot machine 10 of the second embodiment of the present invention will be described below. The processing in the normal game is the same as the processing previously described using FIG. 8 in the first embodiment, and thus processing in the bonus game will be described below.

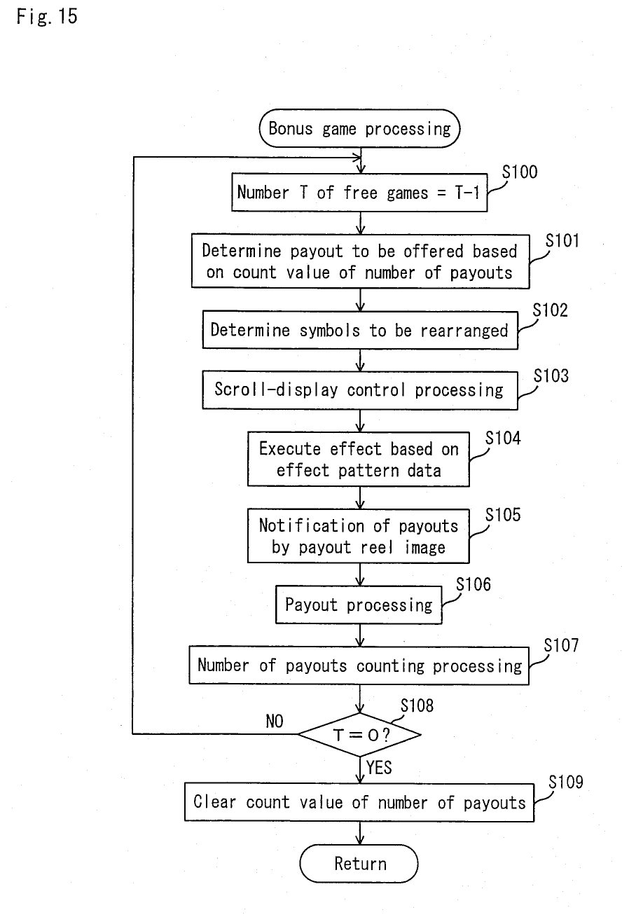

FIG. 15 is a flowchart showing a subroutine of the bonus game processing according to the second embodiment of the present invention.

In the bonus game processing, the main CPU 41 first executes processing of subtraction of 1 from the value of the number of times T of the free games (step S100).

Next, the main CPU 41 determines a payout to be offered in the ongoing free game (step S101) based on the count value of the number of coin-outs as the payout in the bonus game.

In the bonus game processing, the number of coins offered as the payout is counted in each of the free games (see step S107). The count value for the first free game is 0, and the value is cumulatively accumulated in the bonus game.

In the processing of step S101, the main CPU 41 determines a payout amount for the ongoing free game by means of random numbers in a manner that the payout amount becomes equal to or less than a remaining payout amount obtained by subtracting the count value at the time from the total payout amount determined prior to execution of the bonus game. For example, when the total payout amount is 30, and the count value of the number of payout at the time is 26, then the payout in the ongoing free game is determined among the number of coins of 0, 1, 2, 3, 4 by means of random numbers.

On the other hand, in the processing of step S101, the main CPU 41 determines whether or not the value T is 0 with reference to the result of the subtraction of the number of times T of the free games in step S100. When the value T is 0, namely, the ongoing free game is the last free game, the payout amount is determined so that the number of payout should be equal to the above-mentioned remaining payout amount. For example, when the total payout amount is 30, the count value of the number of payout at the time is 26, and the value T is 0 (i.e. ongoing free game is the last free game), the payout is determined to be 4 coins.

Next, the main CPU 41 determines symbols to be rearranged to the display blocks 28 of the lower-side image display panel 16 by means of random numbers (step S102).

Next, the main CPU 41 controls scrolling of the symbols on the display blocks 28 (step S103). Specifically, the main CPU 41 scroll-displays and stops the symbols on the display blocks 28 so as to establish the combination of the symbols determined to be rearranged in step S102.

Subsequently, the main CPU 41 executes an effect based on the selected effect pattern data (step S104). A plurality of kinds of effect pattern data are stored in the RAM 43 in association with the total payout amount and the number of free games in the bonus game. The corresponding relation between the total payout amount and the number of free games in the bonus game with the effect pattern data is as described in the first embodiment using FIG. 4.

The processing of step S104 is executed specifically by generating an effect for gradually enhancing expectation of the player by outputting images or sounds as the free game turns go on, depending on the determined total payout amount (see FIG. 5 and FIG. 6).

Next, the main CPU 41 displays the payout reel image to the lower-side image display panel 16, and after executing scrolls of numbers showing the payout, stops the images of the numbers showing the payout determined in step S101 (step S105).

Thereafter, the main CPU 41 pays out coins based on the result determined in step S101 (step S106), and executes processing to count the number of payout (step S107). In step S107, the main CPU 41 accumulates the number of coin-outs to the count value stored in the RAM 43.

Next, the main CPU 41 determines whether or not the value T of the number of times of the free games is 0 (step S108). Namely, the main CPU 41 determines whether or not the free games have been played for a determined number of times.

When determining that the value T is not 0, the main CPU 41 returns the processing to step S100.

On the other hand, when determining that the value T is 0, the main CPU 41 clears the count value of the number of payout stored in the RAM 43 (step S109), and terminates the present subroutine.

As mentioned above, the slot machine 10 according to the second embodiment of the present invention has the lower-image display panel 16 (display) capable of arranging symbols. Moreover, the slot machine 10 has the motherboard 40 (controller) programmed to execute the following processing of (a) executing a normal game in which the symbols are rearranged and displayed to the lower-image display panel 16 (display), (b) determining whether or not to execute a bonus game in which a free game is played over a plurality of times, the free game executing rearrangement and display of the symbols to the lower-image display panel 16, (c) determining a total payout amount in the bonus game, and (d) executing, when it is determined in the processing (b) that the bonus game will be executed, rearrangement and display of the symbols to the lower-image display panel 16 in each of the free games constituting the bonus game, while determining a payout amount offered in each of the free games in a manner that the payout amount becomes equal to or less than a remaining payout amount obtained by subtracting a total amount of payout having been offered up to the time in the bonus game from the total payout amount determined in the processing (c), and then notifying the determined payout amount.

Namely, on the above slot machine 10, a total payout game is determined prior to execution of the bonus game, while the determination of the payout is controlled, independently to the rearrangement of the symbols, so that the total of the payout amounts of the respective free games constituting the bonus game should not surpass the above-mentioned total payout amount. Therefore, it becomes possible to control the payout amount in the bonus game by adjusting a payout amount in each of the free games with reference to the payout amount determined prior to execution of the bonus game. As a result, an effect which more accurately reflects the total payout amount in the bonus game can be performed.

Moreover, since the payout amount in the bonus game is controlled by making an adjustment in each of the free games, data showing payout patterns in each of the free games do not need to be stored. Therefore, it is possible to reduce the memory capacity to be used.

Further, since the payout amount in the bonus game is controlled by making an adjustment in each of the free games, the payout amount in the bonus game can be adjusted irrespective of the number of the free games constituting the bonus game. Therefore, the number of the free games can be variously changed.

Additionally, since the payout in each of the free games is determined irrespective of rearrangement of the symbols, it is not necessary to determine the corresponding relation between the rearranged symbols and the payout in advance. In addition, it becomes possible to employ various payouts to be offered, such as setting of a larger variety of payout patterns than the number of combinations of the rearranged symbols.

Furthermore, according to the slot machine 10, the control to adjust the payout amount in the bonus game to be equal to the above-mentioned total payout amount is performed in the last free game in the bonus game. By performing this control, it becomes possible to more accurately adjust the payout amount in the bonus game.

It is to be noted that, although the above description on the present embodiment has discussed the case where the determination on whether or not the subject free game is the last free game is made by counting (subtracting) the number of times of the free games, it is also possible in the present invention to employ a configuration in which, for example, determination to set the subject free game as the last game is made in each of the free games.

According to the slot machine 10, since the payout in each of the unit games is notified by an image, the player can more accurately recognize the payout.

Furthermore, according to the slot machine 10 bonus game is played after a total payout amount in the bonus game has been determined, and further, an effect is executed based on effect pattern data corresponding to the determined total payout amount. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an effect in accordance with the total payout amount to be offered can be executed, it becomes possible to avoid a condition where a payout expected from the effect is significantly different from the actual total payout amount, and therefore it becomes possible to prevent the player from being mistrustful of the game.

Moreover, since an effect in accordance with the total payout amount determined prior to execution of the bonus game can be executed as a series of effects over a plurality of unit games, it is possible to gradually raise the expectation of the player for the results of the bonus game each time the unit game is played. It is thus possible to further increase amusement of the bonus game.

In the second embodiment, the case was described where the payout amount offered in the free game is notified by displaying the payout reel image other than the symbols. However, in the present invention, the method for notifying the payout is not limited to this example. For example, the notification may be performed by displaying an image showing the payout (i.e. image of numbers) so as to be superimposed on the rearranged symbols, or may be performed by generating a sound.

According to the first and the second embodiments, the case was described where the payout amount in the bonus game is controlled to be equal to the total payout amount determined prior to execution of the bonus game. However, in the present invention, the payout in the bonus game may be controlled so as to be included within a predetermined range that includes the total payout amount determined prior to execution of the bonus game.

According to the first and the second embodiments, the case was described where effect pattern data are corresponded to a total payout amount in the bonus game and the number of free games constituting the bonus game. However, in the present invention, the number of free games constituting the bonus game may be fixed, and the effect pattern data may be corresponded only to the total payout amount of the bonus game.

Further, in the case of determining the total payout amount in the bonus game after the bonus game has been decided to be executed in the normal game as in the first and the second embodiments, the total payout amount in the bonus game may be determined based on a result of the normal game executed until the bonus game has been decided to be executed. For example, when a large number of the normal game have been played before the bonus game is decided to be executed, the total payout amount in the bonus game may be determined to be a relatively large value.

Moreover, in the first and the second embodiments, the case was described where the total payout amount in the bonus game is determined after the bonus game has been decided to be executed in the normal game. However, in the present invention, the timing for determining the total payout amount in the bonus game is not particularly limited so long as the timing is before the execution of the bonus game. For example, the timing may be determined when game media are betted in the normal game.

Furthermore, although the case was described in the first and the second embodiments where the slot machine 10 is a video slot machine, the gaming machine in the present invention may be a mechanical slot machine provided with reels.

Although the present invention has been described with reference to embodiments thereof, these embodiments merely illustrate specific examples, not restricting the present invention. The specific structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there has been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming machine, comprising
a display capable of arranging symbols; and
a controller,
said controller programmed to execute processing of
(a) executing a normal game in which said symbols are rearranged and displayed to said display,
(b) determining whether or not to execute a bonus game in which a unit game is played over a plurality of times, said unit game executing rearrangement and display of said symbols to the display and determining a payout based on the rearranged symbols or a combination of those symbols,
(c) determining a total payout amount in said bonus game, and
(d) executing, when it is determined in said processing (b) that the bonus game will be executed, rearrangement and display of the symbols to the display in a manner that a payout amount offered in each of said unit games constituting the bonus game becomes equal to or less than a remaining payout amount obtained by subtracting a total amount of payout having been offered up to the time in the bonus game from the total payout amount determined in said processing (c).

2. The gaming machine according to claim 1, wherein
said processing (d) is processing of executing rearrangement and display of the symbols to said display in a manner that a payout amount offered in the last unit game in the bonus game becomes equal to said remaining payout amount.

3. The gaming machine according to claim 1, further comprising
a memory that stores a plurality of kinds of effect pattern data for use in executing an effect, each of said effect pattern data being corresponded to the total payout amount in said bonus game, wherein
said controller is further programmed to execute the processing of
(e) selecting one effect pattern data out of the effect pattern data corresponded to the total payout amount determined in said processing (c), among the plurality of kinds of said effect pattern data stored in said memory, and
(f) executing, when it is determined in said processing (b) that said bonus game will be executed, an effect based on the effect pattern data selected in said processing (e) in each of said unit games constituting said bonus game.

4. A gaming machine, comprising
a display capable of arranging symbols; and
a controller,
said controller programmed to execute processing of
(a) executing a normal game in which said symbols are rearranged and displayed to said display,
(b) determining whether or not to execute a bonus game in which a unit game is played over a plurality of times, said unit game executing rearrangement and display of said symbols to said display,
(c) determining a total payout amount in said bonus game, and
(d) executing, when it is determined in said processing (b) that the bonus game will be executed, rearrangement of said symbols to said display in each of said unit games constituting said bonus game, while determining a payout amount offered in each of said unit games so as to be equal to or less than a remaining payout amount obtained by subtracting a total amount of payout having been offered up to the time in the bonus game from the total payout amount determined in said processing (c), and then notifying said determined payout amount.

5. The gaming machine according to claim 4, wherein
said processing (d) includes processing of determining a payout amount to be offered in the last unit game in said bonus game to be equal to said remaining payout amount, and processing of notifying the determined payout amount.

6. The gaming machine according to claim 4, wherein
said processing (d) is processing of, when it is determined in said processing (b) that the bonus game will be executed, executing rearrangement of said symbols to said display in each of said unit games constituting said bonus game, while determining a payout amount offered in each of said unit games so as to be equal to or less than a remaining payout amount obtained by subtracting a total amount of payout having been offered up to the time in the bonus game from the total payout amount determined in said processing (c), and then notifying said determined payout amount by displaying an image to said display.

7. The gaming machine according to claim 4, further comprising
a memory that stores a plurality of kinds of effect pattern data for use in executing an effect, each of said effect pattern data being corresponded to the total payout amount in said bonus game, wherein
said controller is programmed to further execute the processing of
(e) selecting one effect pattern data out of the effect pattern data corresponded to the total payout amount determined in said processing (c), among the plurality of kinds of said effect pattern data stored in said memory, and
(f) executing, when it is determined in said processing (b) that said bonus game will be executed, an effect based on the effect pattern data selected in said processing (e) in each of said unit games constituting said bonus game.

8. A method for controlling a gaming machine, comprising the steps of:
(a) executing a normal game in which said symbols are rearranged and displayed to said display,
(b) determining whether or not to execute a bonus game in which a unit game is played over a plurality of times, said unit game executing rearrangement and display of said symbols to the display and determining a payout based on the rearranged symbols or a combination of those symbols,
(c) determining a total payout amount in said bonus game, and
(d) executing, when it is determined in said step (b) that the bonus game will be executed, rearrangement and display of the symbols to the display in a manner that a payout amount offered in each of said unit games constituting the bonus game becomes equal to or less than a remaining payout amount obtained by subtracting a total amount of payout having been offered up to the time in the bonus game from the total payout amount determined in said step (c).

9. The method for controlling a gaming machine according to claim 8, wherein
said step (d) is step of executing rearrangement and display of the symbols to said display in a manner that a payout amount offered in the last unit game in the bonus game becomes equal to said remaining payout amount.

10. The method for controlling a gaming machine according to claim 8, further comprising the steps of:
(e) selecting one effect pattern data out of the effect pattern data corresponded to the total payout amount determined in said step (c), among the plurality of kinds of said effect pattern data stored in said memory corresponded to the total payout amount in said bonus game for use in executing an effect, and
(f) executing, when it is determined in said step (b) that said bonus game will be executed, an effect based on the effect pattern data selected in said step (e) in each of said unit games constituting said bonus game.
